(19) United States
(12) Patent Application Publication
(10) Pub. No.: US 2023/0141288 A1
(43) Pub. Date: May 11, 2023

(54) COMMUNICATION NETWORK BASE STATION WITH ROTMAN LENS

(71) Applicant: General Radar Corporation, Belmont, CA (US)

(72) Inventors: Jon WILLIAMS, San Francisco, CA (US); Dmitry TURBINER, Dallas, TX (US); Brian WILLIAMS, Issaquah, WA (US); Christian KURZKE, Saratoga, CA (US); David POWELL, Oakland, CA (US); Ilia LEBEDEV, Cambridge, MA (US); Sergey KLYPIN, Sammamish, WA (US); Barnabas FUNG, San Mateo, CA (US); Devin MATTHEWS, San Francisco, CA (US)

(21) Appl. No.: 18/153,771

(22) Filed: Jan. 12, 2023

Related U.S. Application Data
(63) Continuation-in-part of application No. 17/026,253, filed on Sep. 20, 2020.
(60) Provisional application No. 63/034,937, filed on Jun. 4, 2020.
(60) Provisional application No. 63/034,769, filed on Jun. 4, 2020.
(60) Provisional application No. 63/034,751, filed on Jun. 4, 2020.
(60) Provisional application No. 63/034,729, filed on Jun. 4, 2020.
(60) Provisional application No. 63/034,675, filed on Jun. 4, 2020.
(60) Provisional application No. 63/033,023, filed on Jun. 1, 2020.
(60) Provisional application No. 63/032,999, filed on Jun. 1, 2020.

(51) Int. Cl. H04B 1/44; H01Q 1/24; H01Q 19/06; H01Q 3/36

(52) U.S. Cl. CPC H04B 1/44; H01Q 1/246; H01Q 19/06; H01Q 3/36; H04W 88/08

(57) ABSTRACT

A base station for a communication network comprising at least one transmit planar component and at least one receive planar component is provided. Each of the planar components includes a first end, a second end located opposite the first end, a cavity space and an M number of antennas. The cavity space is bounded by a B number of beam ports along a first side of the cavity space and by an M number of array ports along a second side of the cavity space. The cavity space is in operative communication with the beam ports and with the array ports to form a Rotman lens. The M number of antennas are arranged in an array and are located along the second end of the planar component. Each of the antennas is in operative communication with a corresponding one of the array ports.

### CROSS REFERENCE TO RELATED APPLICATIONS

The present application is a continuation-in-part of U.S. patent application Ser. No. 17/026,253, filed Sep. 20, 2020, which claims priority to U.S. Provisional Patent Application No. 63/032,999, filed Jun. 1, 2020; U.S. Provisional Patent Application No. 63/033,023, filed Jun. 1, 2020; U.S. Provisional Patent Application No. 63/034,675, filed Jun. 4, 2020; U.S. Provisional Patent Application No. 63/034,729, filed Jun. 4, 2020; U.S. Provisional Patent Application No. 63/034,751, filed Jun. 4, 2020; U.S. Provisional Patent Application No. 63/034,769, filed Jun. 4, 2020; and U.S. Provisional Patent Application No. 63/034,937, filed Jun. 4, 2020. The entire contents and disclosure of these applications are incorporated by reference herein.

### FIELD OF THE INVENTION

The present disclosure relates to apparatus and methods of operating a communication network and, more particularly, apparatus and methods of operating a base station in communication network.

### BACKGROUND

The dramatic growth in the number of smartphones, tablets, wearables, and other data-consuming devices, coupled with the advent of enhanced multimedia applications, has resulted in a tremendous increase in the volume of mobile data traffic. According to industry estimates, this increase in data traffic is expected to continue in the coming years and cellular networks might need to deliver as much as 100-1000 times the capacity of current commercial cellular systems. While 4G technologies address some of capacity demands of future mobile broadband users, a mobile broadband user expects to be seamlessly connected all the time, at any location, to any device. This poses stringent requirements on the fifth generation (5G) network, which must provide users with a uniform and seamless connectivity experience regardless of where they are and what device/network they connect to.

Existing 5G system architecture, and specifically 5G base stations, suffer from low energy efficiency and thus consume large amounts of power, when parameters such a spectral efficiency, number of users, number of radio frequency chains, are set to be equal.

### SUMMARY

In one example, a base station for a communication network is provided. The base station comprises at least one transmit planar component and at least one receive planar component. Each of the planar components includes a first end, a second end located opposite the first end, a cavity space and M number of antennas. The cavity space is bounded by B number of beam ports along a first side of the cavity space and by M number of array ports along a second side of the cavity space. The cavity space is in operative communication with the beam ports and with the array ports to form a Rotman lens. The M number of antennas are arranged in an array and are located along the second end of the planar component. Each of the antennas is in operative communication with a corresponding one of the array ports.

In general, in some aspects, the subject matter of the present disclosure encompasses a base station for a communication network, in which the base station includes at least one transmit component, and at least one receive component, each of the transmit components of the at least one transmit component and each of the receive components of the at least one receive components including a corresponding: a first end; a second end located opposite the first end; a cavity space bounded by a plurality of beam ports along a first side of the cavity space and by a plurality of array ports along a second side of the cavity space, the cavity space being in operative communication with the beam ports and with the array ports to form a Rotman lens; and multiple antennas that are arranged in an array and are located along the second end, in which each antenna of the multiple antennas is in operative communication with a different corresponding array port of the plurality of array ports.

Implementations of the base station can include one or more of the following features. For example, in some implementations, the base station includes: multiple radio frequency (RF) chains; a signal processor coupled to the plurality of RF chains; a transmit matrix switch operatively coupled to the signal processor and to the at least one transmit component; and a receive matrix switch operatively coupled to the signal processor and to the at least one receive component, in which the signal processor is in operative communication with the transmit matrix and the receive matrix through the plurality of RF chains.

The at least one RF chain of the multiple RF chains can include both a digital-to-analog converter and an up converter or both an analog-to-digital converter and a down converter.

In some implementations, a number of antennas is selected such that a half power beamwidth of each antenna of the multiple antennas is 1.5 degree or less. The half power beamwidth of each antenna of the multiple antennas can be about 1 degree.

In some implementations, the number of antennas is 88.

In some implementations, a number of beam ports for the at least one transmitting component is 88 and a number of beam ports for the at least one receiving component is 32.

In some implementations, each of the at least one transmit component and the at least one receive component further includes: a first set of waveguides extending between the first end and the beam ports; and a second set of waveguides extending between the array ports and the second end.

In some implementations, the at least one transmit component, and the at least one receive component are planar components.

In general, in another aspect, the subject matter of the present disclosure encompasses a base station for a communication network. The base station includes an analog beamforming section that includes at least one transmit component, and at least one receive component, each transmit component of the at least one transmit component and each receive component of the at least one receive component including a corresponding: a first end; a second end located opposite the first end; a cavity space bounded by multiple beam ports along a first side of the cavity space and by multiple array ports along a second side of the cavity space, the cavity space being in operative communication with the beam ports and with the array ports to form a Rotman lens; and multiple antennas that are arranged in an array and are located along the second end, in which each antenna of the multiple antennas is in operative communication with a different corresponding array port of the multiple array ports.

Implementations of the foregoing base station can include one or more of the following features. For example, in some implementations, the base station includes a digital beamforming section that includes: multiple radio frequency (RF) chains; and a signal processor coupled to the multiple RF chains. The analog beamforming section further can include: a transmit matrix switch operatively coupled to the signal processor and to the at least one transmit component, and a receive matrix switch operatively coupled to the signal processor and to the at least one receive component, in which the signal processor is in operative communication with the transmit matrix and the receive matrix through the multiple RF chains. In some implementations, the at least one RF chain of the multiple RF chains includes both a digital-to-analog converter and an up converter or both an analog-to-digital converter and a down converter.

In some implementations, a number of antennas is selected such that a half power beamwidth of each antenna of the multiple antennas is 1.5 degree or less. The half power beamwidth of each antenna of the multiple antennas can be about 1 degree.

In some implementations, the number of antennas is 88.

In some implementations, a number of beam ports for the at least one transmit component is 88 and a number of beam ports for the at least one receive component is 32.

In some implementations, each of the at least one transmit component and the at least one receive component further includes: a first set of waveguides extending between the first end and the beam ports; and a second set of waveguides extending between the array ports and the second end.

In some implementations, the at least one transmit component, and the at least one receive component are planar components.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic representation of an example embodiment of a radar system in accordance with the present disclosure.

FIG. 2 is a schematic illustration of an example embodiment of a front end including a transmit module and a receive module.

FIG. 3 is a schematic illustration of an example embodiment of a transmit planar component and a receive planar component.

FIG. 4 is a schematic illustration of an example embodiment of a half block of a transmit planar component and a half block of a receive planar component where waveguides and a Rotman lens are formed thereon.

FIG. 5 is a schematic illustration of a close-up view of an example embodiment of a polarization rotator on the half block of the transmit planar component.

FIG. 6 is a schematic illustration of an example polarization rotator including a first section, an iris section and a second section.

FIG. 7A is a schematic illustration of a cross-sectional view across an example first section of a polarization rotator of a planar component.

FIG. 7B is a schematic illustration of an example polarization of waves in a first section of a polarization rotator.

FIG. 8A is a schematic illustration of a cross-sectional view across an example iris section of the polarization rotator of the planar component;

FIG. 8B is a schematic representation of an example of polarization of waves in the iris section of the polarization rotator;

FIG. 9A is a cross-sectional view across the second section of the polarization rotator of a planar component;

FIG. 9B is a schematic representation of an example of polarization of waves in the second section of the polarization rotator;

FIG. 10 is a schematic illustration of an example embodiment of a front end where a Rotman lens and a transmission lines are formed with microstrips;

FIG. 11 is a schematic illustration of an example embodiment of a half block of a planar component for a front end device including a Rotman lens with sidewall absorbers;

FIG. 12 shows a computer graphic illustration of an example embodiment of a fixture to test performance of a sidewall absorber;

FIG. 13 is a graph showing the minimum reflection (S11) and the maximal transmission (S12) for the iris section for given dimensions of the iris section;

FIG. 14 is an illustration of reflections around example triangular teeth of sidewall absorbers of the Rotman lens;

FIG. 15 is a schematic illustration of an example base station implementing the Rotman lens;

FIG. 16 is a graph plotting energy efficiency versus spectral efficiency for base stations supporting 200 beams and implemented with various types of technology; and

FIG. 17 is a graph plotting energy efficiency versus spectral efficiency for base stations support 8 beams and implemented with various types of technology.

### DETAILED DESCRIPTION

Range-finding systems use reflected waves to discern, for example, the presence, distance and/or velocity of objects. Radio Detection And Ranging (radar) and other rangefinding systems have been widely employed in applications, by way of non-limiting example, in autonomous vehicles such as self-driving cars, as well as in wireless communications modems of the type employed, such as in Massive-MIMO (multiple-in-multiple-out) networks, 5G wireless telecommunications, all by way of non-limiting example.

The radar system may include optimized RF front-end device(s) aiding in achieving higher resolution by improving azimuth resolution, elevation resolution, or any combination thereof. Azimuth resolution is the ability of a radar system to distinguish between objects at similar range but different bearings. Elevation resolution is the ability of a radar system to distinguish between objects at similar range but different elevation. Angular resolution characteristics of a radar are determined by the antenna beam-width represented by the −3 dB angle which is defined by the half-power (−3 dB) points. In some embodiments, radar system or phased array system disclosed herein may have a −3 dB beam-width of 1.5 degree or less in both azimuth resolution and elevation resolution. In particular, the radar system can be configured to achieve finer azimuth resolution and elevation resolution by employing an RF front-end device having two linear antennas arrays arranged perpendicularly and a Rotman lens as a phase shifting network, as will be described below.

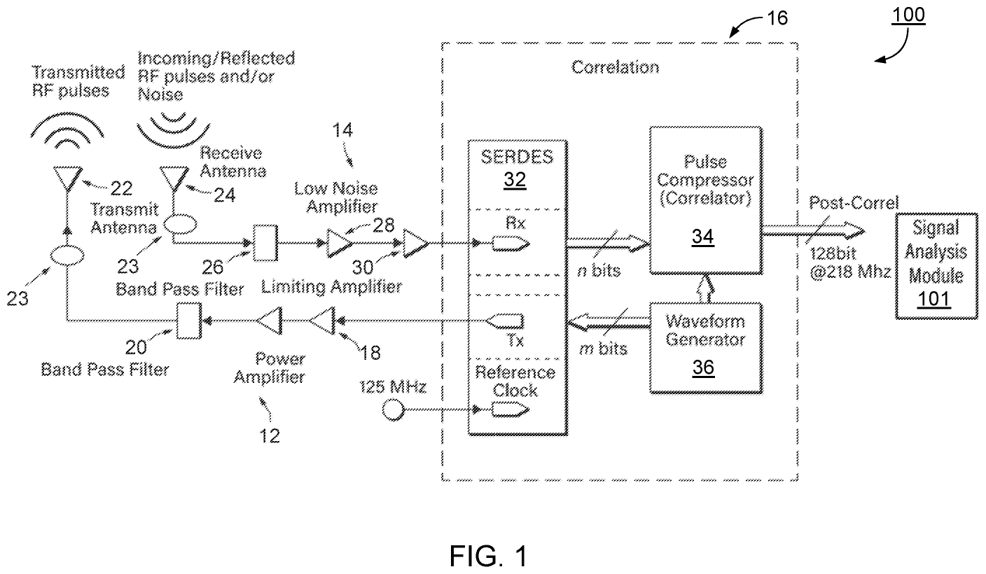

FIG. 1 shows a schematic illustration of an example radar system 100 having the abovementioned functionalities. The radar system 100 may include a millimeter wave radar that emits a low power millimeter wave operating at 76-81 GHz (with a corresponding wavelength of about 4 mm). The radar system can also operate at other frequency ranges that are below 76 GHz or above 81 GHz. The radar system may comprise any one or more elements of a conventional radar system, a phased array radar system, an AESA (Active Electronically Scanned Array) radar system, a synthetic aperture radar (SAR) system, a MIMO (Multiple-Input Multiple-Output) radar system, and/or a phased-MIMO radar system.

A conventional radar system may be a radar system that uses radio waves transmitted by a transmitting antenna and received by a receiving antenna to detect objects. A phased array radar system may be a radar system that manipulates the phase of one or more radio waves transmitted by a transmitting and receiving module and uses a pattern of constructive and destructive interference created by the radio waves transmitted with different phases to steer a beam of radio waves in a desired direction.

The radar system 100 may be provided on a movable object to sense an environment surrounding the movable object. Alternatively, the radar system may be installed on a stationary object.

A movable object can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be carried by a living subject, or taken off from a living subject, such as a human or an animal.

In some cases, the movable object can be an autonomous vehicle which may be referred to as an autonomous car, driverless car, self-driving car, robotic car, or unmanned vehicle. In some cases, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In some instances, the radar systems may be integrated into a vehicle as part of an autonomous-vehicle driving system. For example, a radar system may provide information about the surrounding environment to a driving system of an autonomous vehicle. An autonomous-vehicle driving system may include one or more computing systems that receive information from a radar system about the surrounding environment, analyze the received information, and provide control signals to the vehicle's driving systems (e.g., steering wheel, accelerator, brake, or turn signal).

The radar system 100 that may be used on a vehicle to determine a spatial disposition or physical characteristic of one or more targets in a surrounding environment. The radar system may advantageously have a built-in predictive model for object recognition or high-level decision making. For example, the predictive model may determine one or more properties of a detected object (e.g., materials, volumetric composition, type, color, etc.) based on radar data. Alternatively or additionally, the predictive model may run on an external system such as the computing system of the vehicle.

The radar system may be mounted to any side of the vehicle, or to one or more sides of the vehicle, e.g. a front side, rear side, lateral side, top side, or bottom side of the vehicle. In some cases, the radar system may be mounted between two adjacent sides of the vehicle. In some cases, the radar system may be mounted to the top of the vehicle. The system may be oriented to detect one or more targets in front of the vehicle, behind the vehicle, or to the lateral sides of the vehicle.

A target may be any object external to the vehicle. A target may be a living being or an inanimate object. A target may be a pedestrian, an animal, a vehicle, a building, a sign post, a sidewalk, a sidewalk curb, a fence, a tree, or any object that may obstruct a vehicle travelling in any given direction. A target may be stationary, moving, or capable of movement.

A target object may be located in the front, rear, or lateral side of the vehicle. A target object may be positioned at a range of about 1, 2, 3, 4, 5, 10, 15, 20, 25, 50, 75, or 100 meters from the vehicle. A target may be located on the ground, in the water, or in the air. A target object may be oriented in any direction relative to the vehicle. A target object may be orientated to face the vehicle or oriented to face away from the vehicle at an angle ranging from 0 to 360 degrees.

A target may have a spatial disposition or characteristic that may be measured or detected. Spatial disposition information may include information about the position, velocity, acceleration, and other kinematic properties of the target relative to the terrestrial vehicle. A characteristic of a target may include information on the size, shape, orientation, volumetric composition, and material properties, such as reflectivity, material composition, of the target or at least a part of the target.

A surrounding environment may be a location and/or setting in which the vehicle may operate. A surrounding environment may be an indoor or outdoor space. A surrounding environment may be an urban, suburban, or rural setting. A surrounding environment may be a high altitude or low altitude setting. A surrounding environment may include settings that provide poor visibility (night time, heavy precipitation, fog, particulates in the air). A surrounding environment may include targets that are on a travel path of a vehicle. A surrounding environment may include targets that are outside of a travel path of a vehicle. A surrounding environment may be an environment external to a vehicle.

Referring to FIG. 1, in some embodiments, the radar system 100 may comprise a front end in which at least two phased array modules are arranged perpendicularly with each other and the received signals are processed by the correlator of the phased array module. The processed data (e.g., post correlated data) may further be processed by a signal analysis module 101 for object recognition, constructing point cloud image data and other analysis. In some embodiments, a phased array module of the front end 10 may comprise a transmit logic 12, receive logic 14 and correlation logic 16 illustrated in FIG. 1. The phased array module and SERDES may include those described in U.S. Pub. No. 2018/0059215 entitled “Beam-Forming Reconfigurable Correlator (Pulse Compression Receiver) Based on Multi-Gigabit Serial Transceivers (SERDES)”, which is incorporated by reference herein in its entirety.

For example, the transmit logic 12 may comprise componentry of the type known in the art for use with radar systems (and particularly, for example, in pulse compression radar systems) to transmit into the environment or otherwise a pulse based on an applied analog signal. In the illustrated embodiment, this is shown as including a power amplifier 18, band pass filter 20 and transmit antenna 22, connected as shown or as otherwise known in the art.

The receive logic 14 comprises componentry of the type known in the art for use with RADAR systems (and particularly, for example, in pulse compression RADAR systems) to receive from the environment (or otherwise) incoming analog signals that represent possible reflections of a transmitted pulse. In point of fact, those signals may often include (or solely constitute) noise. In the illustrated embodiment, the receive logic includes receive antenna 24, band pass filter 26, low noise amplifier 28, and limiting amplifier 30, connected as shown or as otherwise known in the art.

The correlation logic 16 correlates the incoming signals, as received and conditioned by the receive logic 14, with the pulse transmitted by the transmit logic 12 (or, more aptly, in the illustrated embodiment, with the patterns on which that pulse is based) in order to find when, if at all, there is a high correlation between them. Illustrated correlation logic comprises serializer/deserializer (SERDES) 32, correlator 34 and waveform generator 36, coupled as shown (e.g., by logic gates of an FPGA or otherwise) or as otherwise evident in view of the teachings hereof.

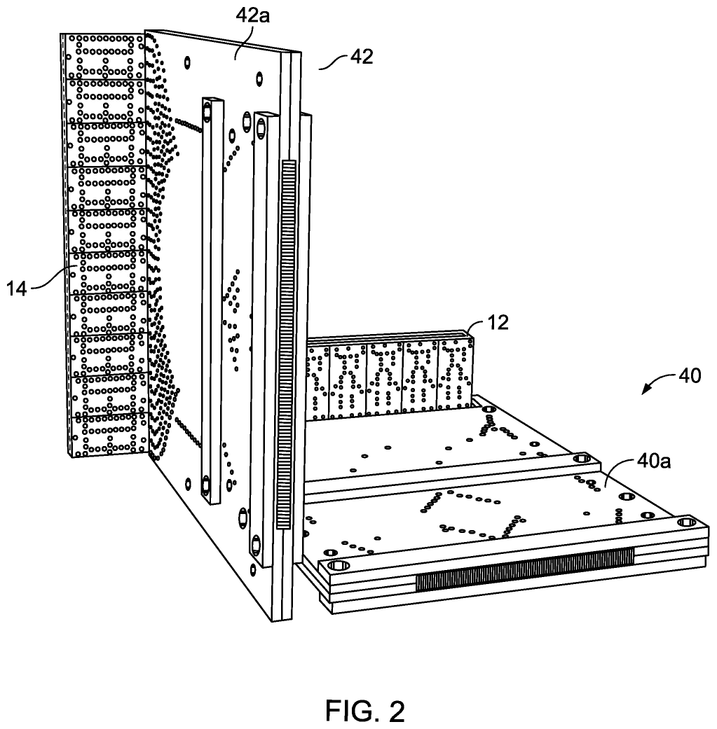

FIG. 2 illustrates an example embodiment of a front-end apparatus for a millimeter wave radar. A millimeter wave radar may emit a low power millimeter wave operating at 76-81 GHz (with a corresponding wavelength of about 4 mm). The radar system can also operate at other frequency range that is below 76 GHz or above 81 GHz. The radar system may comprise any one or more elements of a conventional radar system, a phased array radar system, an AESA (Active Electronically Scanned Array) radar system, a synthetic aperture radar (SAR) system, a MIMO (Multiple-Input Multiple-Output) radar system, and/or a phased-MIMO radar system. A conventional radar system may be a radar system that uses radio waves transmitted by a transmitting antenna and received by a receiving antenna to detect objects.

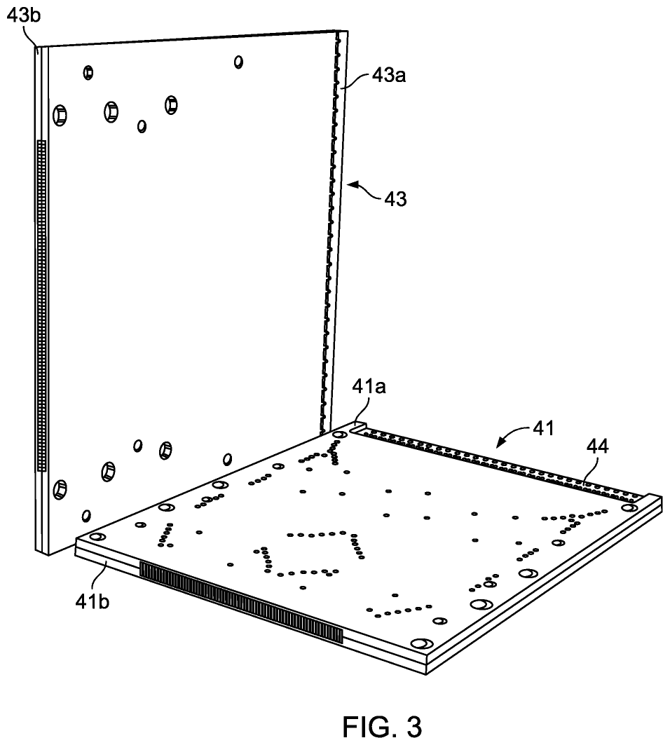

As shown in FIG. 2, the front-end apparatus may include phased array modules, i.e., a transmit module 40 and a receive module 42. Each phased array module may include a front end device and a phased array logic. Specifically, the transmit module may include a transmit front end device 40a and a transmit logic 12 while the receive module may include a receive front end device 42a and a receive logic 14. Each of the transmit front end device 40a and the receive front end device 42a may be embodied as a planar component such that the transmit front end device 40a and the receive front end device 42a include a transmit planar component and a receive planar component respectively. FIG. 3 shows the transmit planar component 41 and the receive planar component 43 in isolation. Moreover, each of the planar components 41, 43 may be operatively connected with the corresponding phased array logic 12 or 14 by including, for example, a slot 44 (FIG. 3) to accommodate the corresponding phased array logic.

The planar component 41/43 may be embodied in the form of a rectangular substrate or plate, as shown in FIG. 3, and may include a first end 41a/43a and a second end 41b/43b that are located on opposite longitudinal ends of the rectangular substrate. The first end 41a/43a of the planar component 41/43 may be operatively connected to the phased array logic 12/14 at the slot 44, and the second end 41b/43b of the planar component 41/43 may include an array of antennas 22/24. The phased array logic 12/14 may connect to the planar component 41/43 at the slot 44 forming a right angle near the first end 41a/43a. The array of transmit antennas 22 and the array of receive antennas 24 may be perpendicular to one another if the transmit planar component 41 and the receive planar component 43 are arranged to be perpendicular to one another (FIGS. 2-4).

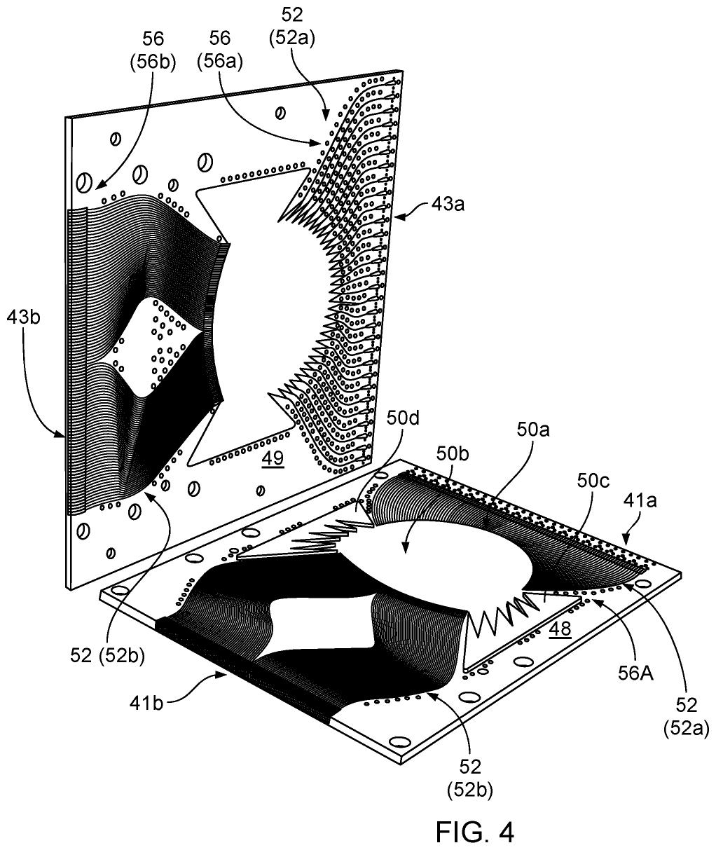

The planar component 41/43 may formed from a split block assembly in that the planar component 41/43 is formed by assembling a plurality of blocks. For example, the planar component 41/43 may be formed from half blocks 48/49 that substantially mirror one another along a plane that divides the planar component 41/43 in half thereby forming two symmetrical halves. FIG. 4 only shows one of the two half blocks 48/49.

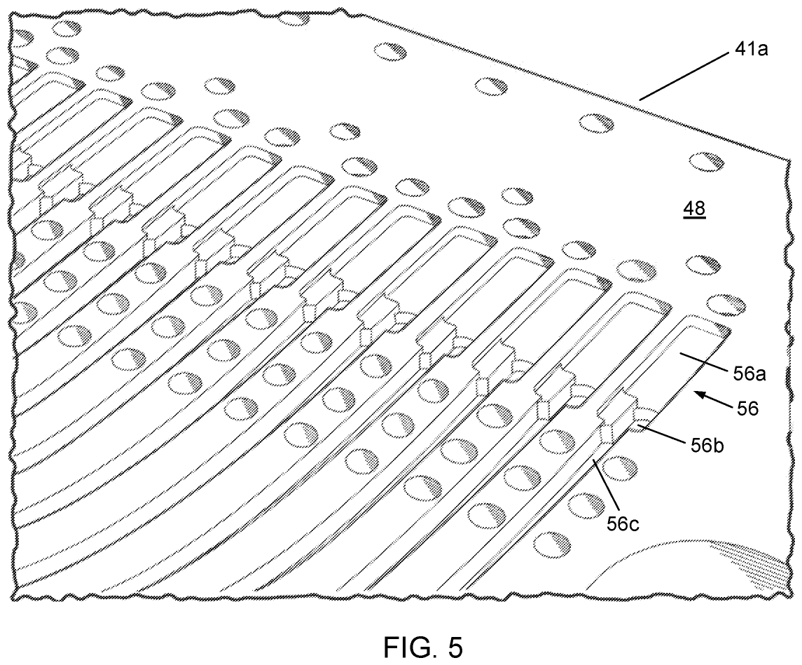

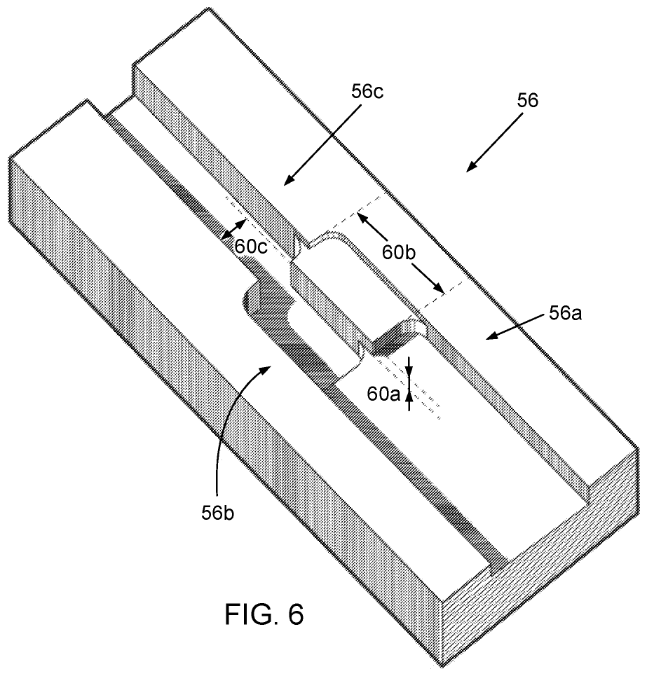

The inner surfaces of the blocks of the planar components 41/43 are formed with recesses or cavities that form the inner structure of the planar components 41/43 as will be described below. The recesses or cavities on the blocks 41a/43a may be formed by a variety of manufacturing methods known in the art (e.g., computer numerical control (CNC) machining, injection molding, or the like) capable to achieving desired fabrication tolerances. As shown in FIGS. 5-6, some curved surfaces (i.e., chamfers) may remain on the planar components 41/43 due to the non-zero diameter of the end bit of the CNC milling machine which may be 20 mils, for example.

The planar component 41/43 may be made of metals (e.g., aluminum), metallic alloys, thermoplastics, other materials known in the art, or a combination thereof. For example, the planar component 41/43 may be made of thermoplastics primarily, and be plated or coated with metals (e.g., gold) or metallic alloys to reduce weight.

In some embodiments, a phased array module 40/42 may include a phase shifting network in the RF front-end device. In some embodiments, the phase shifting network may be implemented using a Rotman lens (e.g., see Rotman lens 23 in FIG. 1), which may be interposed between the phased array logic (e.g., the transmit logic 12 or the receive logic 14 in FIG. 1) and the array of multiple transmit antennas (e.g., antennas 22/24 in FIG. 1). In some cases, the RF front-end device may comprise a phase shifting network, such as the Rotman lens 23, and a linear antennas array.

The transmit antennas 22 and/or the receive antennas 24 can be any suitable type of antennas. For example, the antennas 22/24 may be a microstrip patch array, Vivaldi antennas, slot coupled patches, horns and others. In some embodiments, the antennas 22/24 may be microstrip bipodal vivaldi antennas that are fed by the Rotman lens 23. For example, the antennas array may be coupled to the array ports of the Rotman lens 23 on a one-to-one basis.

FIG. 4 is a schematic illustration of an example embodiment of a half block of a transmit planar component and a half block of a receive planar component where waveguides and a Rotman lens are formed thereon. The Rotman lens shown in FIG. 4 is an example of the Rotman lens 23 shown in FIG. 1 and may include a cavity space 50, and a perimeter of the cavity space 50 may include a first side, a second side that is opposite the first side, a third side, and a fourth side that is opposite the third side. Input ports or beam ports 50a may be located on the first side while output ports or array ports 50b may be located on the second side of the cavity space 50. The Rotman lens may be configured such that the beam ports 50a are near the first end 41a/43a of the planar component 41/43 while the array ports 50b are near the second end 41b/43b thereof.

If one of the beam ports 50a is excited, the electromagnetic waves will be emitted into the cavity space 50 and will reach a corresponding one of array ports 50b. The shape of contour with the array ports 50b and the length of waveguides 52, which connect the ends 41a/41b/43a/43b of the planar component 41/43 and the ports 50a/50b, are determined so that, a progressive phase taper is created on the array antennas 22/24 and thus a beam is formed at a particular direction in the space.

In the present embodiment, the Rotman lens for the transmit front end device 40a has 63 beam ports and 72 array ports, while the Rotman lens for the receive front end device 42a has 30 beam ports and 72 array ports. Moreover, the front end 10 has an azimuth scanning angle of 50 degrees and an elevation scanning angle of 40 degrees. These values may vary depending on how the Rotman lens is embodied. Moreover, the front end 10 may include 72 transmit antennas and 72 receive antennas where the antennas 22, 24 are equidistantly spaced apart from one another.

The Rotman lens may serve as a robust and low-cost broadband phase shifting network for the disclosed RF front-end devices 40a/42a and structures. In these cases, active circuitry may be integrated with the beam ports of the Rotman lens, and the lens itself may then be optimized to provide accurate phasing. In accordance with another aspect of the disclosure, some embodiments may include a Rotman lens with enhanced focusing functionality to provide the phasing with low power loss.

The third side and the fourth side of the Rotman lens may include dummy ports or sidewall absorbers 50c, 50d, such as radio frequency absorbers, are formed to suppress reflections from the sides of the Rotman lens. The radio frequency absorbers may be made of wave absorbing materials such as Eccosorb® MCS, LS26 or BSR.

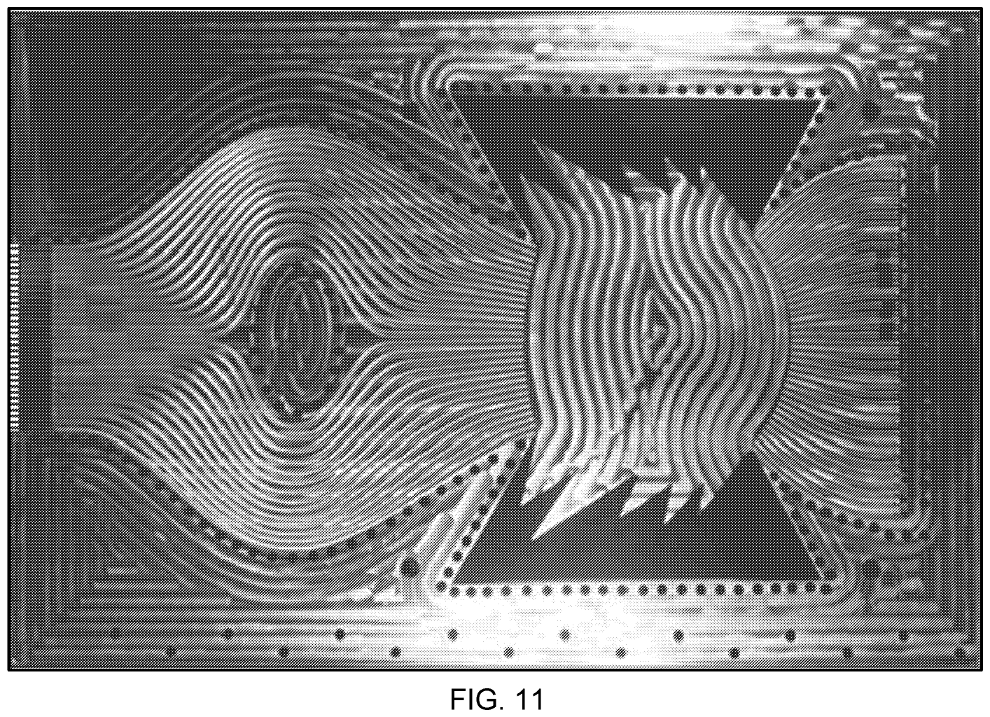

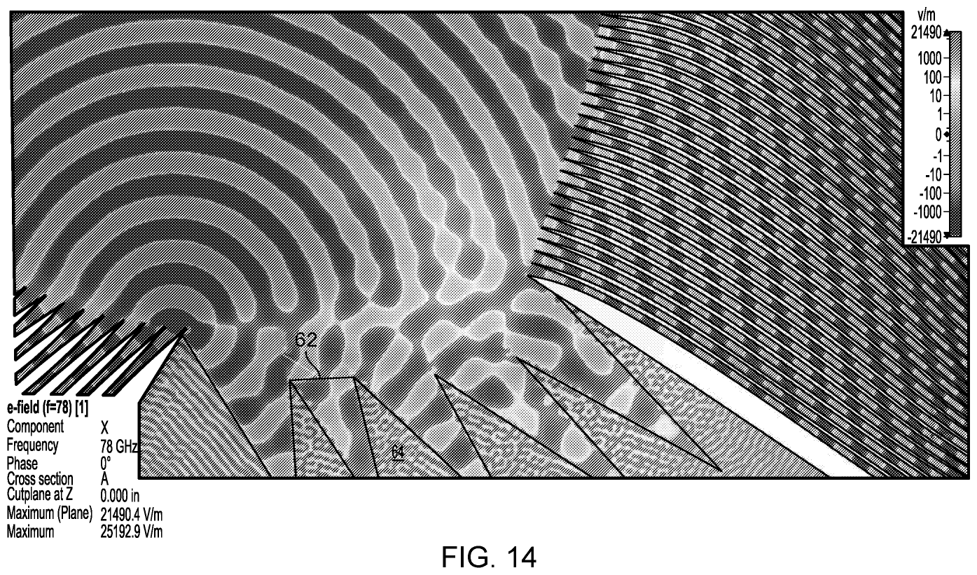

FIGS. 4 and 11 illustrate embodiments of the Rotman lens with jagged sidewall absorbers 50c, 50d. Sidewall absorbers 50c, 50d having shapes shown in FIG. 11 may be effective at attenuating the wavefront of the incident pulses. The shape of the sidewall absorbers 50c, 50d may include a plurality of sharp triangular “teeth.” As shown in FIG. 14, these triangular teeth 64 may be formed such that the imaginary lines 62 extending between adjacent vertices of the triangular teeth 64 pointing into the cavity space 50 of the Rotman lens, may be oriented to be substantially normal to the curvature of the wavefront. Under such a configuration, a substantial amount of energy may be captured in-between the teeth 64 thereby allowing for an effective dissipation by the sidewall absorbers 50c, 50d, as observable in FIG. 14.

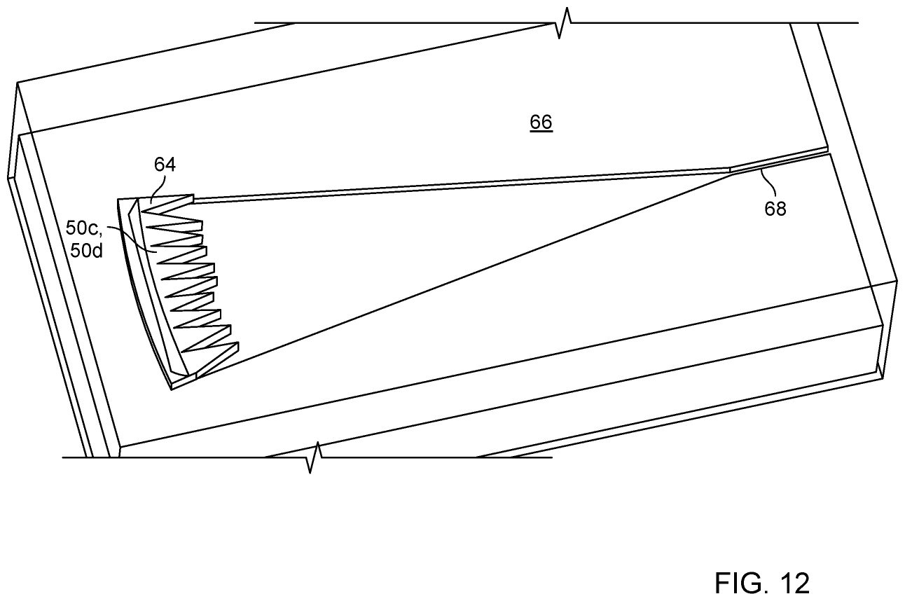

The properties of a sidewall absorber 50c/50d may be tested on a fixture 66 a simulated embodiment of which is illustrated in FIG. 12. The properties of a sidewall absorber 50c/50d may be tested on the fixture 66 by feeding a signal into the fixture through its input waveguide port and measuring the reflection coefficient S11 on a Network Analyzer with waveguide millimeter-wave test heads, a simulated embodiment of which is illustrated in FIG. 12. Specifically, by emitting waves through the slot 68 towards the triangular teeth 64 of a sidewall absorber 50c/50d secured in a depression of the fixture 66 and measuring the amount of reflection from the triangular teeth 64, it is possible to test the effectiveness of the sidewall absorber 50c/50d.

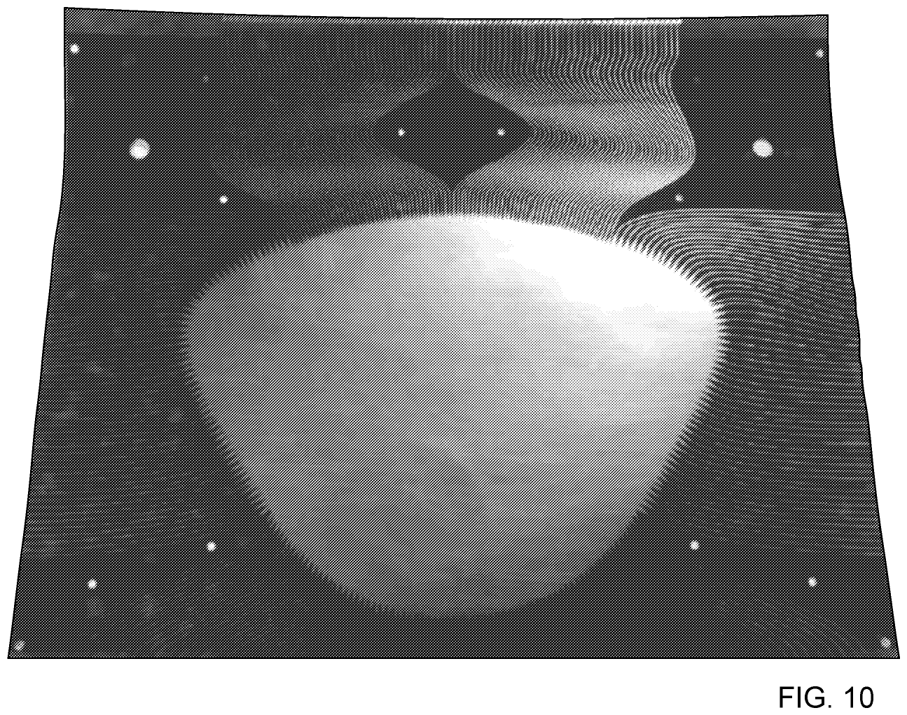

As shown in FIG. 10, the Rotman lens 23 can be implemented using waveguides, microstrip, stripline technologies or any combination of the above. In some embodiments, the Rotman lens may be microstrip-based Rotman lens. In some embodiments, the Rotman lens 23 may be a waveguide-based Rotman lens. In some cases, waveguides may be used in place of transmission lines.

In the embodiments of FIGS. 4-9B, the planar component 41/43 further includes waveguides 52 between the first end 41a/43a and the beam ports 50a and between the array ports 50b and the second end 41b/43b. The waveguides 52 may be embodied as rectangular waveguides integrated into the planar component 41/43 such that the waveguides 52 form walls that guide the propagation of electromagnetic waves through the planar component 41/43 during transmission or reception of antenna signals from the first end 41a to the second end 41b or vice versa.

Each of the waveguides 52 may provide a hollow space through which the electromagnetic waves propagate. While FIGS. 5-6 show only one half of the hollow space of the waveguides 52, the hollow space of the half blocks 48/49 may form an enclosed space that extends along the planar component 41/43 and may take on various geometries to affect the polarization of the waves at different locations of the front end device 40a/42a. Specifically, the shape of the cross-section of the hollow space may be described based on a reference rectangular cross-section 54 with a given width in the width directions and a given height in the height directions. The waveguide 52 may include a section where the cross-section of the hollow space is as large as the reference rectangular cross-section 54 or smaller than the reference rectangular cross-section 54 as will be described below.

Each of the waveguides 52 of the Rotman lens 23 may further include a polarization rotator 56 to control the polarization of the waves out of and into the phased array logics. FIGS. 5-6 show an example embodiment of the polarization rotator 56 integrated onto the waveguides 52. The polarization rotator 56 may include a first section 56a, an iris section 56b, and a second section 56c which are continuously arranged in a longitudinal direction of the planar component 41/43.

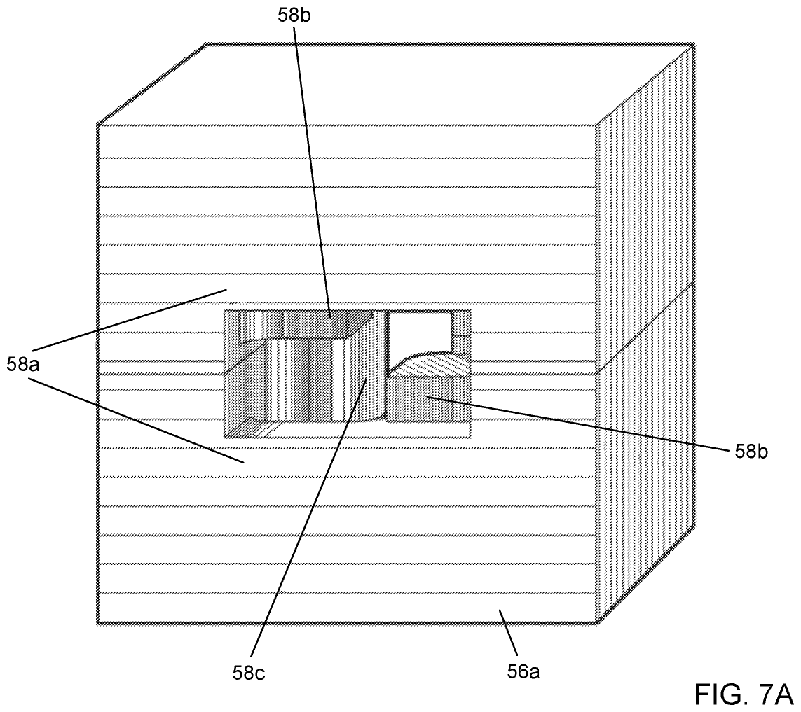

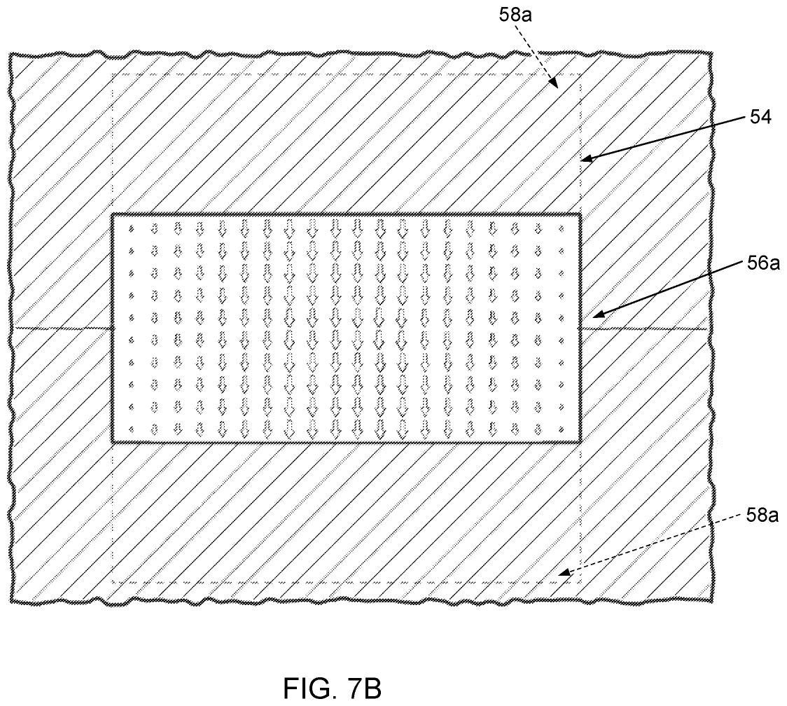

FIG. 5 shows an inner side of a half block 48 of the transmit planar component 41 where the polarization rotator 56 is formed near the first end 41a. The polarization rotator 56 may be similarly formed near the first end 43a of the receive planar component 43. In the first section 56a of the polarization rotator 56 (FIGS. 7A-7B), the waveguide 52 may include a first set of cuboid obstructions 58a that protrude into the hollow space in opposite height directions such that the height of the cross-section of the first section 56a is less than the given height of the reference rectangular cross-section 54 while the width of the cross-section of the first section 56a may be the same as the given width of the reference rectangular cross-section 54. Such height and width may be substantially constant throughout the first section 56a in the longitudinal directions.

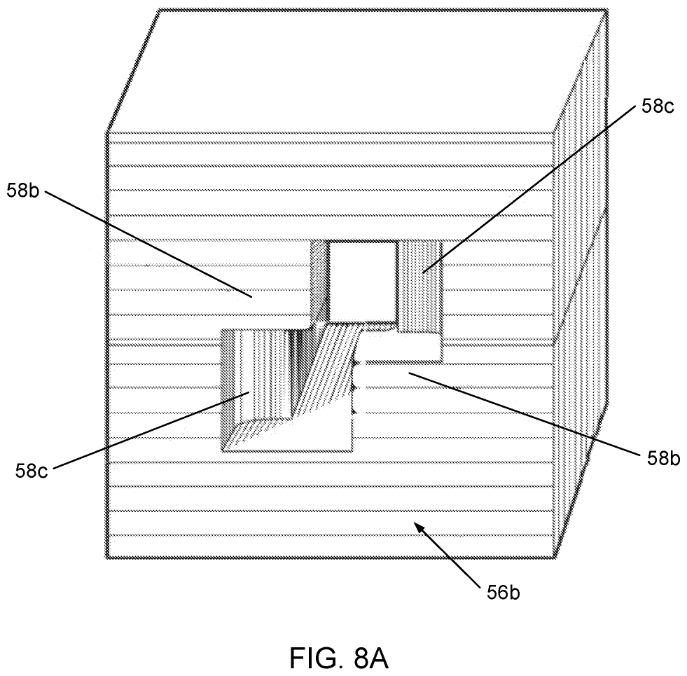

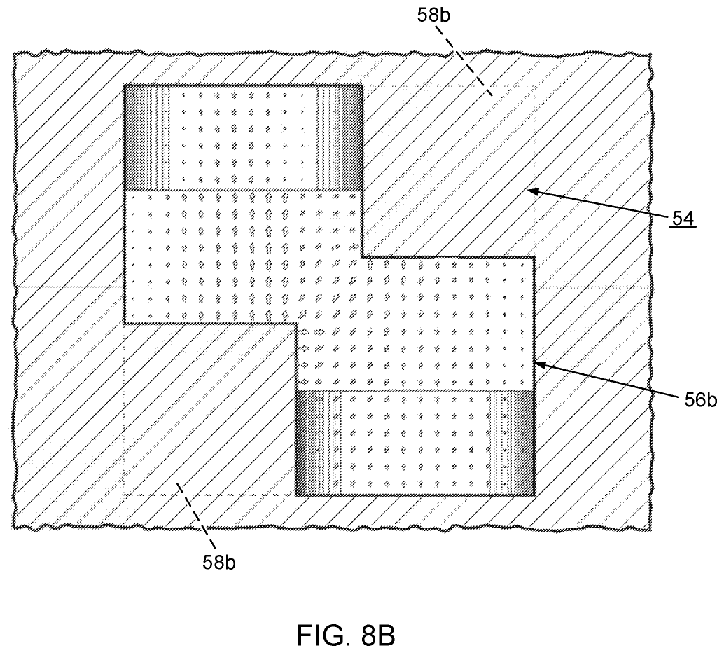

In the iris section 56b of the polarization rotator 56 (FIGS. 8A-8B), the waveguide 52 may include a diagonal set of cuboid obstructions 58b that protrude into the hollow space from diagonally opposite corners of the reference rectangular cross-section 54 such that an octagonal, cross-sectional area of the iris section 56b is obtained. This cross-sectional area of the iris section 56b may be substantially constant throughout the iris section 56b in the longitudinal directions.

It should be noted that FIG. 8A shows a cross-section across the iris section 56b of the polarization rotator 56 observed from the viewpoint of the first section 56a such that the second section 56c is visible behind the iris section 56b while FIG. 8B shows a cross section across the iris section 56b of the polarization rotator 56 observed from the viewpoint of the second section 56c such that first section 56a is visible behind the iris section 56b.

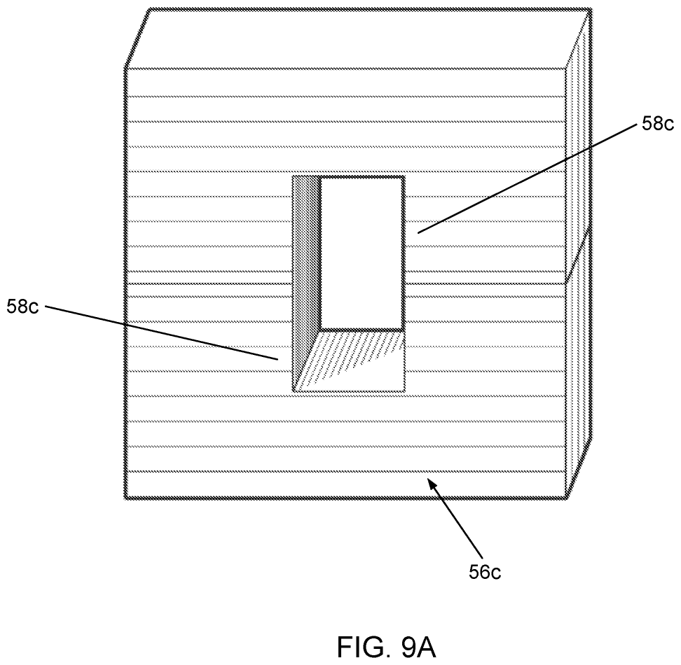

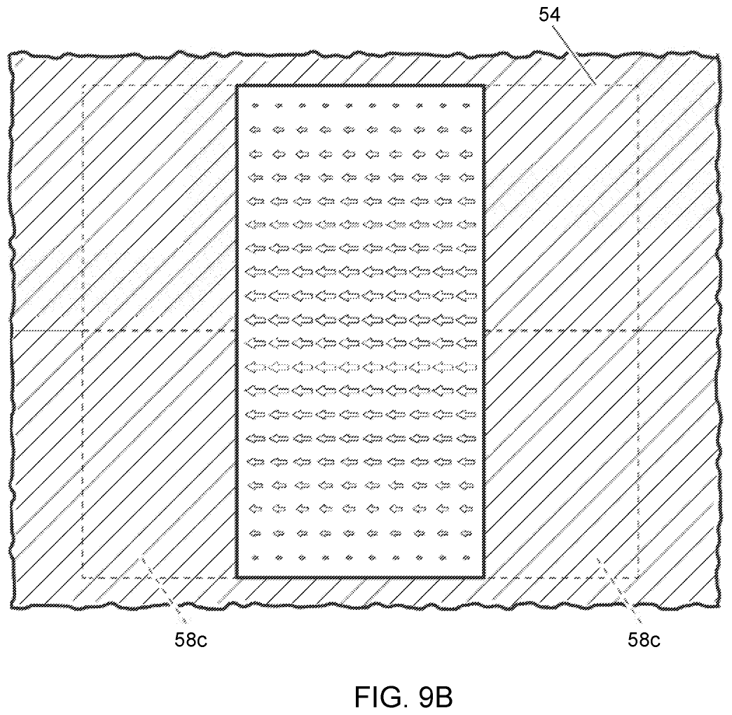

In the second section 56c of the polarization rotator 56 (FIGS. 9A-9B), the waveguide 52 may include a second set of cuboid obstructions 58c that protrude into the hollow space from opposite width directions such that the width of the cross-section of the second section 56c is less than the given width of the reference rectangular cross-section 54 while the height of the cross-section of the second section 56c may be the same as the given height of the reference rectangular cross-section 54 (FIG. 9A). Such height and width may be substantially constant throughout the second section 56c in the longitudinal directions.

Various dimensions of the iris section 56b (FIG. 6) can affect different parameters of the radar system. The height 60a of the cuboid obstructions 58b in the iris section 56b can be used to tune total effective bandwidth and can affect a balance between bandwidth and central band frequency. The length 60b of the cuboid obstructions 58b of the iris section 56b can be used to tune the effective band center. The gap 60c of the iris section 56b, which is measured between a sidewall of the cuboid obstructions 58b and a sidewall of the second section 56c, can affect both the bandwidth and insertion loss of the polarization rotation. In one example embodiment, the height 60a of the cuboid obstructions 58b of the iris section 56b, the length 60b of the cuboid obstructions 58b of the iris section 56b, and the gap 60c of the iris section 56b may respectively be 0.017 in., 0.094 in., and 0.035 in. Moreover, the entire length of the polarization rotator that is the combined length of the first section 56a, the iris section 56b, and the second section 56c may be less than 2λ where λ is equal to a wavelength of the waves traveling through the front end.

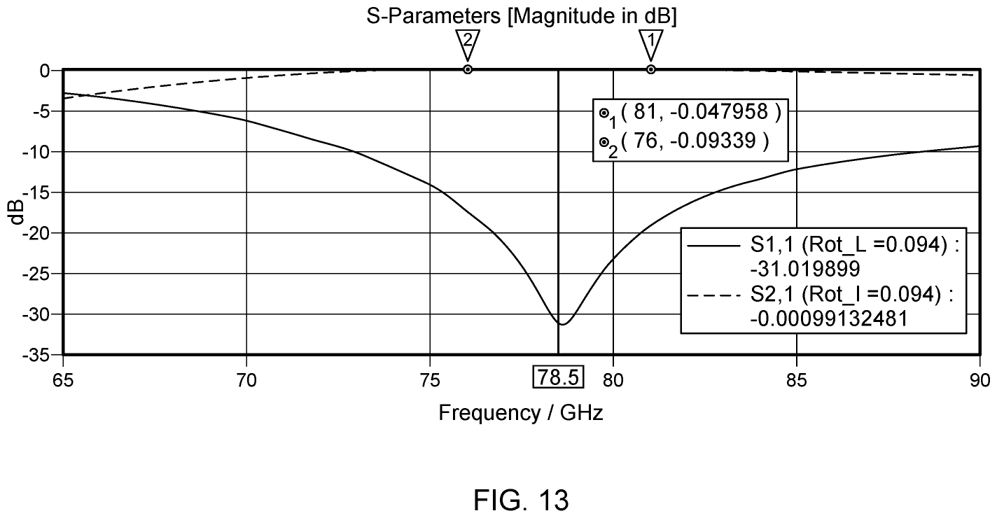

The aforementioned dimensions of the iris section 56b may affect the performance of the antenna which may be described in terms of S-parameters (where SNM represents the power transferred from Port M to Port N in a multi-port network), as shown in the graph of FIG. 13. In one embodiment of the iris section 56, the dimensions of the iris section 56b may control the locations of a minima of S11 (minimum reflection) and a maxima of S21 (maximum transmission) as well as the beamwidth. In the example of FIG. 13, S11 has a minima of about −31.019899 dB at 78.5 GHz while S21 has a maxima of about −0.00099132481 dB.

Due to the complex interaction of the tuning parameters, a systematic tuning approach to getting the needed bandwidth, central frequency and insertion loss are needed when designing the polarization rotator 56. The process for tuning should be to pick nominal values for the three aforementioned parameters. Nominal values are based on the waveguide 52 selected and are typically ¼ to 1 times the waveguide long dimension depending on the parameter. Once nominal values are chosen length for the iris section should be tuned to achieve the needed central frequency response. After central frequency response is achieved, the height of the cuboid obstruction 58b should be tuned to get the desired bandwidth and insertion loss. If bandwidth and insertion loss are not achieved, the gap of the iris section 56b can be changed to help insertion loss. The gap of the iris section should typically be 30-50% of the long dimension of the waveguide 52. Deviations from this lead to very narrow bandwidths or high insertion loss. Once the desired insertion loss and bandwidth are achieved a re-tune of the length of the iris section will shift the central frequency back to the desired position from the shift due to adjustments to parameters such as the height of the cuboid obstructions 58b and the gap 60c of the iris section 56.

As shown in FIG. 4, the waveguides 52 extending between the first end 41a/43a and the beam ports 50a of the Rotman lens 23 may form a first set of waveguides 52a in the transmit planar component 41 and the receive planar component 43. Each waveguide in the first set of waveguides 52a may further include one or more polarization rotator(s) 56. In the present embodiment of the front end 10, each waveguide in the first set of waveguides 52a in the transmit planar component 41 and the receive planar component 43 includes a first polarization rotator 56A where the first section 56a of the first polarization rotator 56 is located nearer the first end 41a than the second section 56c thereof.

As further shown in FIG. 4, the waveguides 52 extending between the second end 41b/43b and the array ports 50b of the Rotman lens 23 in the transmit planar component 41 and in the receive planar component 43 may form a second set of waveguides 52b. Each waveguide 52 in the second set of waveguides 52b in the receive planar component 43 may further include one or more polarization rotator 56. In the present embodiment of the front end 10, each waveguide in the second set of waveguides 52b in the receive planar component 43 includes a second polarization rotator 56B which is positioned adjacent the array of antennas 22/24 and in which the first section 56a of the polarization rotators 56 is nearer the second end 43b than the second section 56c thereof.

The electromagnetic waves propagating through the present apparatus may be in the Transverse Electric (TE) 10 mode. The polarization of the waves may be altered by the polarization rotators 56 located throughout the transmit front end device 40a and the receive front end device 42a.

Waves originating from the transmit logic 12 are polarized to be perpendicular to the plane of the Rotman lens 23 (FIG. 7B) but undergo a 90-degree polarization rotation or twist to become polarized parallel to the plane of the Rotman lens (FIG. 9B) as the waves propagate through the first polarization rotators 56A of the first set of waveguides 52a of the transmit planar component 41. Specifically, the waves move through the first polarization rotator 56A (i.e., the first section 56a, the iris section 56b and the second section 56c thereof), and the E-plane of the waves is polarized to be parallel to the plane of the Rotman lens 23 of the transmit planar component 41. Thereafter, the polarization of the waves may be unchanged by propagation through the rest of the transmit front end device 40a, including the Rotman lens 23, before being transmitted from the transmit antennas 22. If the transmit planar component 41 is oriented to be horizontal about the ground, the polarization of the waves would change from vertical to horizontal in the transmit front end device 40a.

As shown in FIGS. 2-4, the linear array of receive antennas 24 is arranged perpendicularly relative to the linear array of transmit antennas 22. Despite this configuration, the receive antennas 24 of the receive front end device 42a may detect the waves that were horizontally polarized and were transmitted by the transmit front end device 40a. The detection of these waves may be improved by the fact that the receive front end device 42a includes two set of polarization rotators 56A, 56B. In other words, the waves arriving at the receive antennas 24 may undergo another 90-degree polarization rotation by the second polarization rotators 56B of the second set of waveguides 52b in the receive planar component 43. Specifically, the waves move through the first section 56a, the iris section 56b and the second section 56c (from FIG. 7B to FIG. 9B) of the second polarization rotator 56B and are polarized to become parallel the plane of the Rotman lens 23 of the receive planar component 43 (or vertical if the receive planar component 43 is positioned vertically about the ground surface). After these detected waves propagate through the Rotman lens, the polarization of these waves may undergo yet another 90-degree polarization rotation at the first polarization rotators 56A of the first set of waveguides 52a of the receive planar component 43. Specifically, the waves move through the second section 56c, the iris section 56b, and the first section 56a (from FIG. 9B to FIG. 7B) of the first polarization rotators 56A and are polarized to become perpendicular to the plane of the Rotman lens 23 of the receive planar component 43 (i.e., with a horizontal polarization about the ground surface if the receive front end device is perpendicular to the ground surface). The waves thus reach the receive logic 14 at the same polarization relative to the phased array logic at which the waves were transmitted from the transmit logic 12.

The first set of waveguides 52a in the transmit planar component 41, the second set of waveguides 52b in the receive planar component 43, and the first set of waveguides 52a in the receive planar component 41 make up the three sets of waveguides 52 that include polarization rotators 56 in the present embodiment of the front end 10. Thus, the waves undergo three 90-degree polarization rotations or twists during propagation through the transmit front end device 40a and the receive front end device 42a.

However, the number of sets of waveguides 52 including polarization rotators 56 may be a different odd number such as one or seven. In an alternative embodiment of the front end 10, there could be polarization rotators 56 in the first set of waveguides 52 on the transmit planar component 41 only and none on the receive planar component 43 such that the total number of sets of waveguides including polarization rotators 56 is one, for example.

Alternatively, while each waveguide in the aforementioned sets of waveguides 52 includes a single polarization rotator 56, it is possible for one waveguide 52 to have more than one polarization rotator 56. For example, each of the first set of waveguides 52a extending between the first end 41a and the beam ports 50a in the transmit planar component 41 may include two polarization rotators 56 (e.g., a first polarization rotator 56A and a second polarization rotator 56B in order of wave propagation), each of the second set of waveguides 52b extending between the array ports 50b and the second end 41b in the transmit planar component 41 may include one polarization rotator 56 (e.g., a first polarization rotator 56A), each the second set of waveguides 52b extending between the second end 43b and the array ports 50b in the receive planar component 43 may include two polarization rotators 56 (e.g., a second polarization rotator 56B and a first polarization rotator 56A in order of wave propagation), and each the first set of waveguides 52a extending between the beam ports 50a and the first end 43a of the receive planar component 43 may include two polarization rotators 56 (e.g., a second polarization rotator 56B and a first polarization rotator 56A in order of wave propagation). In such an alternative arrangement of the polarization rotators 56, there would be a total of seven 90-degree polarization rotations or twists during propagation through the transmit front end device 40a and the receive front end device 42a.

The expression “90-degree polarization rotation” or other expressions relating to rotating the polarization of the waves by “90-degree” or “90 degrees” are meant to include rotation by 270 degrees, 630 degrees, or the like in the opposite rotational direction or rotation by 450 degrees or the like in the same rotational direction as long as the finally reached position can be reached through a rotation by 90 degrees.

In one example arrangement of the front end 10, the transmit module 40 and the receive module 42 may be configured in a bi-static manner. The bi-static configuration may refer to the working configuration where the receiving module 42 and the transmitting module 40 are separated or not co-located. The illustrated example shows that the vertically arranged receive module 42 is configured to be in a receiving mode while the horizontally arranged transmit module 40 is configured to be in a transmission mode. The bi-static Tx/Rx configuration of the two phased array modules may be fixed or switchable. In some cases, the vertical receive module 42 and horizontal transmit module 40 can be switched such that the vertical module is the transmitter and the horizontal module is the receiver.

If the radar system is in the bi-static Tx/Rx configuration, one or more parameters of the antenna arrays (e.g., gain, directivity) for the receiving and transmitting may be different. Similarly, one or more configurations of the Rotman lens or RF absorbers corresponding to one (transmit/receive) front-end device may be different from those of the perpendicularly arranged (receive/transmit) front-end device.

In alternative embodiment (FIG. 10), the front end 10 may feed an array of microstrip patch antennas using microstrip delay-line beamformer. The microstrip patch antennas may be fabricated using printed circuit board technologies. The patch antennas are resonant antennas fed by a true time delay microstrip beamformer without using a lens. An array of Vivaldi antennas may also be connected to the microstrip-based Rotman lens. This may advantageously provide a device with compact and smaller structure, improved accuracy and easy fabrication. In an example receiving module, the patch antennas may be selected (e.g., by selecting patch size and location) such that the patch array operates at the center frequency which is about 78.5 GHz. In some embodiments, the patch array may comprise 32 patches. Those skilled in the art will appreciate that other number of patches that is smaller than or greater than 32 can be utilized.

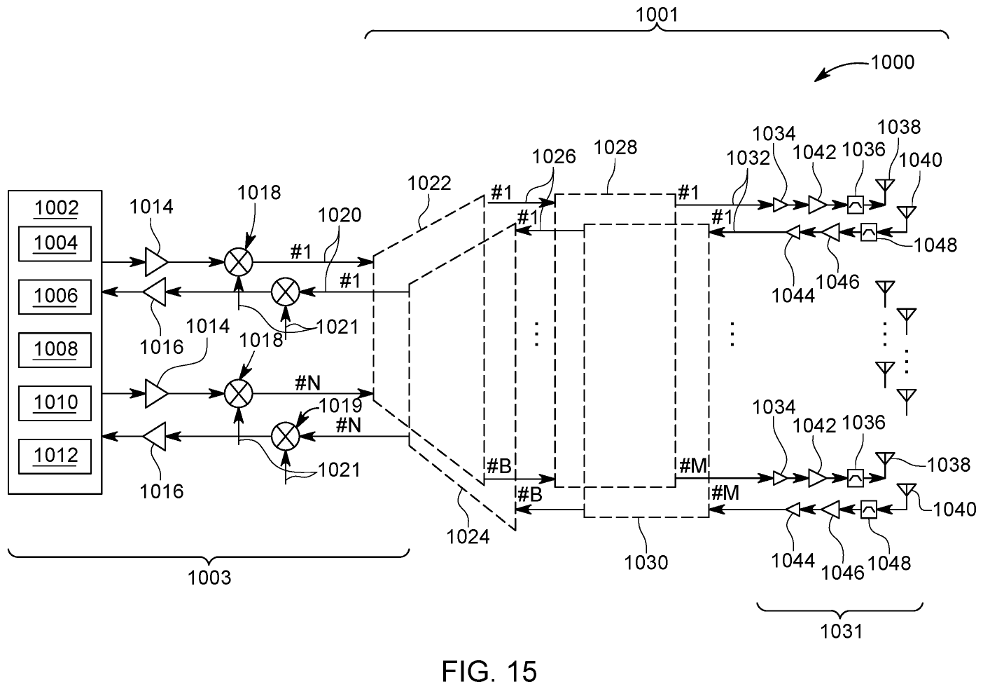

FIG. 15 shows a schematic illustration of an example 5th generation mobile network (5G) system 1000, which is also referred to as a 5G base station. The example 5G base station is equipped with hybrid beamforming in which the analog beamformer in the hybrid beamforming is based on one or more Rotman lenses. The system 1000 may include two separated identical antenna arrays, one for transmitting by transmit antennas 1038 and the other for receiving by receive antennas 1040. As shown in FIG. 15, each of the transmit and receive arrays may be composed of a non-zero number of antenna elements, e.g., M antenna elements, in that there are an M number of transmitting paths and an M number of receiving paths in this architecture. But the number of transmitting paths and the number of receiving paths can be different as well. All parts of the system 1000 may be designed to operate in millimeter-wave frequencies. The radio frequency (RF) head 1031 through each transmitting path may include a preamplifier 1034, a power amplifier 1042, and a bandpass filter 1036 and the RF head 1031 through each receiving path comprises a bandpass filter 1048, a limiter 1046, and a low noise amplifier 1044. The power amplifier is used in each line to satisfy the required Effective Isotropic Radiated Power (EIRP) for 5G base stations.

Hybrid beamforming in this type of 5G system 1000 often includes two sections, i.e., analog beamforming 1001 and digital beamforming 1003. In the embodiment of FIG. 15, the digital beamforming 1003 is applied in the signal processor 1002 to generate an N number of separated and independent signals (RF chains 1020). In an example embodiment, there may be 8 RF chains 1020. Moreover, the network for analog beamforming 1001 in this embodiment is formed of two Rotman lenses 1028, 1030 each of which includes an M number of array ports 1032 and a B number of beam ports 1026 providing multiple orthogonal beams. The number M may be selected such that a half-power beamwidth of each antenna can be, e.g., 1.5 degree or less, such as about a 1-degree beamwidth. For example, for a total beamwidth of the transmitting antenna array or the receiving antenna array of 132 degrees, the number M can be 88, for an individual antenna beamwidth of 1.5 degrees. In some implementations, the same Rotman lens may be utilized for the transmit path and the receive path. In some implementations, the number B of beam ports can be different for the transmit portion of the system 1000 than for the receive portion of the system 1000. For example, the number B of beam ports for the transmitting Rotman lens 1028 can be 88, whereas the number B of beam ports for the receiving Rotman lens 1030 can be 32. In order to select the intended beam ports 1026 to transmit/receive the RF chains 1020 towards/from the targets, a transmit matrix switch 1022 and a receive matrix switch 1024 are provided.

The matrix switches 1022, 1024 connect the N number of RF chains 1020 to the B number of beams provided to the Rotman lenses 1028, 1030. The system 1000 can support an N number of beam(s) simultaneously. For example, in a 5G base station with 8 beams, the matrix switches 1022, 1024 should be able to connect each RF chain 1020 to each beam port 1026 of the Rotman lens 1028, 1030 such that the matrix switch can connect all RF chains 1020 to all beam ports 1026 of the Rotman lens. In the receiving arms 1020 of the digital beamforming portion 1003, the signals in millimeter-wave frequencies received from the matrix switch 1024 are converted to signals in lower frequencies by the down converters 1019 while the signals with frequencies lower than those in the millimeter-wave range in the transmitting arms 1020 of the digital beamforming portion 1003 are converted to signals in millimeter-wave frequencies by the up converters 1018 before being passed to matrix switch 1022. Local oscillator signals 1021 are input into the up converters 1018 and the down converters 1019 for up/down conversion of intermediate frequency (IF) signals. To convert the digital and analog signals to each other, analog-to-digital converters 1016 and digital-to-analog converters 1014 may be provided.

The signal processor 1002 may include a plurality of layers 1004, 1006, 1008, 1010 and 1012 for data transmission in accordance with conventional models such as the open system interconnections (OSI) reference model or the Internet protocol suite. Under the OSI model, the layers may include the physical layer, the data link layer including the media access control (MAC), the network layer, the transport layer, the session layer, the presentation layer, and the application layer. In the OSI model, the physical layer is the layer most closely associated with the physical connection between devices and transmits and/or receives the raw bit-stream over the physical medium. The data link layer defines the format of the data being transmitted/received and is responsible for flow control and error control in intra-network communications. A MAC sublayer within the data-link layer controls the hardware responsible for interaction with the transmission medium. The network layer facilitates data transfer between different networks. The network layer breaks data from the transport layer into packets when sending data or reassembles packets when receiving data. When transmitting, the transport layer takes data from the session layer and breaks it into segments before sending it to the network layer. When receiving, the transport layer reassembles the segments into data that the session layer can consume. The transport layer also can be configured to perform flow control for determining an optimal speed of transmission and to perform error control to ensure that the received data is complete. The session layer is configured to open and close communication between devices. The presentation layer prepares data so that it can be used by the application layer and is configured to perform encryption and compression of data. The application layer includes the protocols for manipulating data for use with user applications. Under the TCP/IP model, the layers may include the network access layer, the Internet layer, the transport layer, and the application layer.

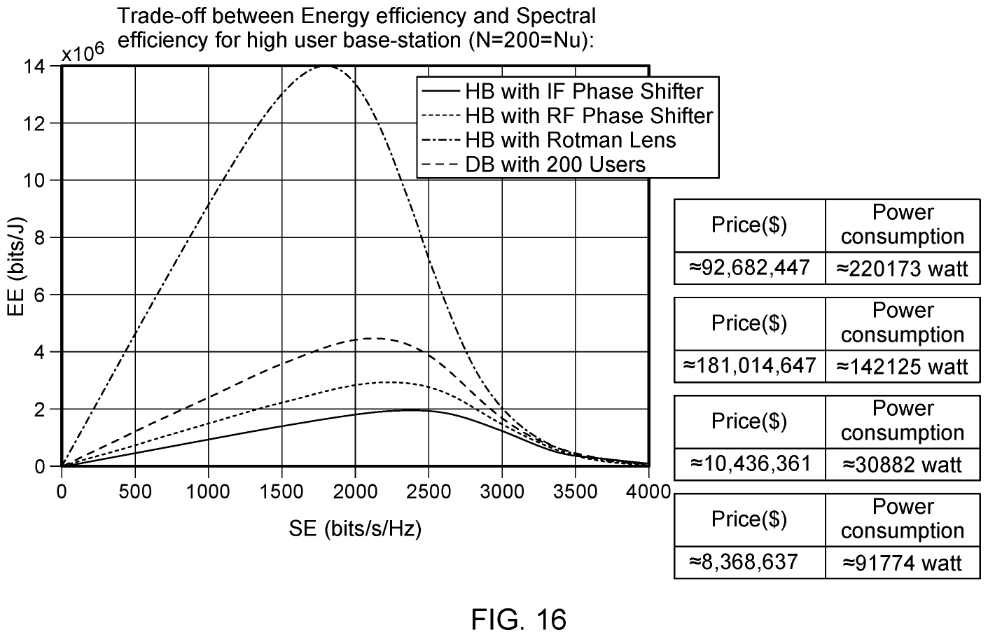

The graph in FIG. 16 illustrates energy efficiency versus spectral efficiency for base stations implemented with different types of technology and corresponding power consumption for each type of technology. The base stations for each technology support 200 beams (Nu=200) and have 200 RF chains. The first type of base stations (‘HB with IF Phase Shifter’) utilizes hybrid beamforming, which combines analog beamforming and digital beamforming, with IF phase shifters. The second type of base stations (‘HB with RF Phase Shifter’) utilizes hybrid beamforming with RF phase shifters. The third type of base stations (‘HB with Rotman Lens’) utilizes hybrid beamforming with Rotman lenses, and the fourth type of base stations (‘DB with 200 beams’) simply utilizes digital beamforming. As observable from the power consumption calculations, the base stations utilizing hybrid beamforming with Rotman lenses provide comparable spectral efficiency performance with significantly better energy efficiency.

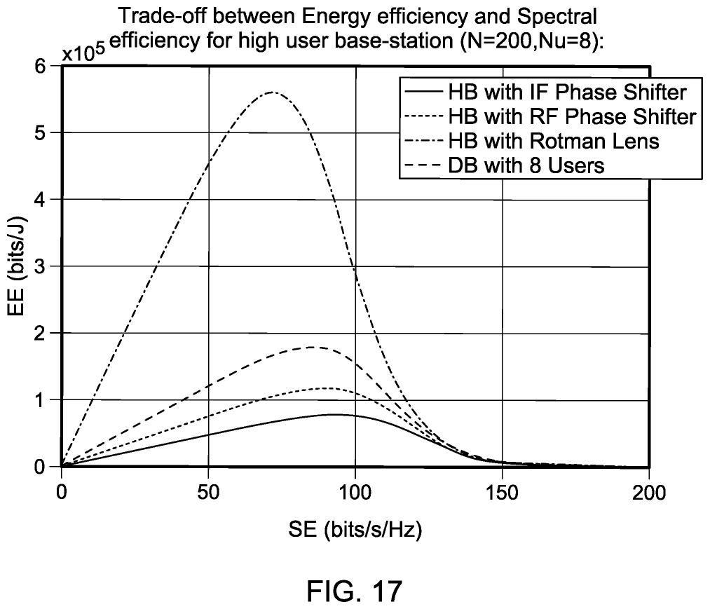

The graph in FIG. 17 also illustrates energy efficiency versus spectral efficiency for base stations implemented with the same four types of technology and having 200 RF chains but producing 8 beams. It can be observed that the base stations utilizing hybrid beamforming with Rotman lenses still provide comparable spectral efficiency performance with significantly better energy efficiency.

Numerous modifications and variations of the present invention are possible in light of the above teachings. It is therefore to be understood that within the scope of the appended claims, the invention may be practiced otherwise than as specifically described herein.

What is claimed is:

1. A base station for a communication network, the base station comprising:
at least one transmit component; and
at least one receive component, each of the transmit components of the at least one transmit component and each of the receive components of the at least one receive components comprising a corresponding:
a first end;
a second end located opposite the first end;
a cavity space bounded by a plurality of beam ports along a first side of the cavity space and by a plurality of array ports along a second side of the cavity space, the cavity space being in operative communication with the beam ports and with the array ports to form a Rotman lens; and
a plurality of antennas that are arranged in an array and are located along the second end, wherein each antenna of the plurality of antennas is in operative communication with a different corresponding array port of the plurality of array ports.

2. The base station of claim 1, further comprising:
a plurality of radio frequency (RF) chains;
a signal processor coupled to the plurality of RF chains;
a transmit matrix switch operatively coupled to the signal processor and to the at least one transmit component; and
a receive matrix switch operatively coupled to the signal processor and to the at least one receive component,
wherein the signal processor is in operative communication with the transmit matrix and the receive matrix through the plurality of RF chains.

3. The base station of claim 2, wherein at least one RF chain of the plurality of RF chains comprises both a digital-to-analog converter and an up converter or both an analog-to-digital converter and a down converter.

4. The base station of claim 1, wherein a number of antennas is selected such that a half power beamwidth of each antenna of the plurality of antennas is 1.5 degree or less.

5. The base station of claim 4, wherein the half power beamwidth of each antenna of the plurality of antennas is about 1 degree.

6. The base station of claim 1, wherein the number of antennas is 88.

7. The base station of claim 1, wherein a number of beam ports for the at least one transmitting component is 88 and a number of beam ports for the at least one receiving component is 32.

8. The base station of claim 1, each of the at least one transmit component and the at least one receive component further comprising:
a first set of waveguides extending between the first end and the beam ports; and
a second set of waveguides extending between the array ports and the second end.

9. The base station of claim 1, wherein the at least one transmit component, and the at least one receive component are planar components.

10. A base station for a communication network, the base station comprising:
an analog beamforming section comprising:
at least one transmit component; and
at least one receive component, each transmit component of the at least one transmit component and each receive component of the at least one receive component comprising a corresponding:
a first end;
a second end located opposite the first end;
a cavity space bounded by a plurality of beam ports along a first side of the cavity space and by plurality of array ports along a second side of the cavity space, the cavity space being in operative communication with the beam ports and with the array ports to form a Rotman lens; and
a plurality of antennas that are arranged in an array and are located along the second end, wherein each antenna of the plurality of antennas is in operative communication with a different corresponding array port of the plurality of array ports.

11. The base station of claim 10, further comprising a digital beamforming section that comprises:
a plurality of radio frequency (RF) chains; and
a signal processor coupled to the plurality of RF chains.

12. The base station of claim 11, wherein the analog beamforming section further comprises:
a transmit matrix switch operatively coupled to the signal processor and to the at least one transmit component, and
a receive matrix switch operatively coupled to the signal processor and to the at least one receive component,
wherein the signal processor is in operative communication with the transmit matrix and the receive matrix through the plurality of RF chains.

13. The base station of claim 11, wherein at least one RF chain of the plurality of RF chains comprises both a digital-to-analog converter and an up converter or both an analog-to-digital converter and a down converter.

14. The base station of claim 10, wherein a number of antennas is selected such that a half power beamwidth of each antenna of the plurality of antennas is 1.5 degree or less.

15. The base station of claim 14, wherein the half power beamwidth of each antenna of the plurality of antennas is about 1 degree.

16. The base station of claim 10, wherein the number of antennas is 88.

17. The base station of claim 10, wherein a number of beam ports for the at least one transmit component is 88 and a number of beam ports for the at least one receive component is 32.

18. The base station of claim 10, wherein each of the at least one transmit component and the at least one receive component further comprises:
a first set of waveguides extending between the first end and the beam ports; and
a second set of waveguides extending between the array ports and the second end.

19. The base station of claim 10, wherein the at least one transmit component, and the at least one receive component are planar components.
